(19) United States
(12) Patent Application Publication
(10) Pub. No.: US 2006/0256580 A1
(43) Pub. Date: Nov. 16, 2006

(54) Backlight assembly and liquid crystal display device having the same

(76) Inventors: Sung-Yong Kang, Suwong-si (KR); Jong-dae Park, Seoul (KR); Jeoung-Gwen Lee, Suwon-si (KR); Yong-Gwang Won, Yongin-si (KR)

Correspondence Address: CANTOR COLBURN, LLP, 55 GRIFFIN ROAD SOUTH, BLOOMFIELD, CT, 06002, US

(21) Appl. No.: 11/431,326

(22) Filed: May 10, 2006

(30) Foreign Application Priority Data
May 10, 2005 (KR) 2005-38946

(51) Int. Cl. F21V 8/00

(52) U.S. Cl. 362/614; 362/621

(57) ABSTRACT

A backlight assembly includes a receiving container, a plurality of lamps, and a diffusion plate. The lamps are received in the receiving container and are arranged substantially in parallel with each other to generate light. The diffusion plate on the lamps includes a plurality of light diffusing parts each having a plurality of embossed patterns corresponding to the lamps. Each of the embossed patterns has a circular shape or a polygonal shape in plan view and a substantially triangular cross-section or a semi-circular cross-section. Each of the embossed patterns is recessed or protruded from a surface of the diffusion plate to form a concave or convex shape, respectively. Therefore, a bright line of the backlight assembly is decreased to improve an image display quality of a display device.

This application claims priority to Korean Patent Application No. 2005-38946, filed on May 10, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a backlight assembly and a liquid crystal display (“LCD”) device having the backlight assembly. More particularly, the present invention relates to a backlight assembly capable of decreasing a bright line to improve an image display quality and an LCD device having the backlight assembly.

2. Description of the Related Art

An LCD device displays an image using a liquid crystal that has optical characteristics such as anisotropy of refractivity and electrical characteristics such as anisotropy of dielectric constant. The LCD device has a thinner thickness, lower driving voltage, lower power consumption, etc., than other display devices such as cathode ray tube (“CRT”) device, plasma display panel (“PDP”) device, etc. Therefore, the LCD device is used in various fields.

The LCD device includes an LCD panel having a thin film transistor (“TFT”) substrate, a color filter substrate, and a liquid crystal layer. The color filter substrate corresponds to the TFT substrate. The liquid crystal layer is interposed between the TFT substrate and the color filter substrate. The LCD panel is a non-emissive type display panel and thus requires a backlight assembly that supplies the LCD panel with a light.

The backlight assembly is classified as either an edge illumination type or a direct illumination type based on a location of a light source within the backlight assembly. In the edge illumination type, the backlight assembly includes a light guiding plate and one or two light sources adjacent to a side surface of the light guiding plate so that the light generated from the light sources in a direction parallel to an LCD panel is redirected and guided into the LCD panel of the LCD device by the light guiding plate. In the direct illumination type, the backlight assembly includes a plurality of light sources under the LCD panel and a diffusion plate between the LCD panel and the light sources so that the light generated from the light sources is directed perpendicularly towards the LCD panel and is diffused and irradiated into the LCD panel by the diffusion plate. In general, a small screen LCD device has the edge illumination type backlight assembly and a large screen LCD device has the direct illumination type backlight assembly that has high luminance.

In the direct illumination type backlight assembly, a portion of the diffusion plate in the direct illumination type backlight assembly on the lamps has greater luminance than a remaining portion of the diffusion plate in the direct illumination type backlight assembly between adjacent lamps so that a bright line is formed by the lamps on the portion of the LCD panel positioned directly above the lamps. The bright line deteriorates an image display quality of the backlight assembly.

### BRIEF SUMMARY OF THE INVENTION

The present invention provides a backlight assembly capable of decreasing a bright line to improve an image display quality.

The present invention also provides an LCD device having the above-mentioned backlight assembly.

In exemplary embodiments of a backlight assembly in accordance with one embodiment of the present invention, the backlight assembly includes a receiving container, a plurality of lamps, and a diffusion plate. The lamps are received in the receiving container. The lamps are arranged substantially in parallel with each other to generate a light. The diffusion plate is disposed over the lamps. The diffusion plate includes a plurality of light diffusing parts, each light diffusing part having a plurality of embossed patterns corresponding to the lamps.

Each of the embossed patterns may have a circular shape or a polygonal shape in plan view.

Each of the embossed patterns may have a substantially triangular shaped cross-section, a semi-elliptical shaped cross-section, or a semi-circular shaped cross-section.

Each of the embossed patterns may be recessed from a surface of the diffusion plate by a predetermined depth to form a concave shape, or may be protruded from the surface of the diffusion plate by a predetermined height to form a convex shape.

Each of the embossed patterns may include a minute protrusion on a surface of the embossed pattern.

Each light diffusing part is separated from an adjacent light diffusing part by a first spacing, and each light diffusing part includes a plurality of columns of the embossed patterns, each column separated from an adjacent column within the light diffusing part by a second spacing less than the first spacing.

In other embodiments of a backlight assembly in accordance with the present invention, the backlight assembly includes a receiving container, a plurality of lamps, and a diffusion plate. The lamps are received in the receiving container. The lamps are arranged substantially in parallel with each other to generate a light. The diffusion plate is disposed over the lamps. The diffusion plate includes a plurality of light diffusing parts, each light diffusing part having a plurality of embossed patterns corresponding to the lamps. Each of the embossed patterns has a plurality of prisms to form a dot shape.

In exemplary embodiments of an LCD device in accordance with the present invention, the LCD device includes a backlight assembly and a display unit. The backlight assembly generates a light. The backlight assembly includes a receiving container, a plurality of lamps, and a diffusion plate. The lamps are received in the receiving container. The lamps are arranged substantially in parallel with each other to generate a light. The diffusion plate is on the lamps. The diffusion plate includes a plurality of light diffusing parts, each light diffusing part having a plurality of embossed patterns corresponding to the lamps. The display unit displays an image using the light generated from the backlight assembly.

In exemplary embodiments of a diffusion plate for diffusing light from a light source, the diffusion plate includes a plurality of light diffusing parts arranged in strips on a surface of the diffusion plate, and a plurality of embossed patterns within each light diffusing part, each embossed pattern having an enclosed periphery and including a plurality of prisms within the enclosed periphery, the prisms arranged substantially parallel to the strips of light diffusing parts.

Each prism may be substantially triangular in cross-section and a plurality of minute protrusions may be provided on a surface of each prism.

A planar surface area may be provided between adjacent light diffusing parts.

In other exemplary embodiments of a diffusion plate for diffusing light from a light source, the diffusion plate includes a plurality of light diffusing parts arranged in strips on a surface of the diffusion plate, each light diffusing part separated from an adjacent light diffusing part by a first spacing, and a plurality of spaced embossed patterns within each light diffusing part, each embossed pattern separated from an adjacent embossed pattern within a same light diffusing part by a second spacing, the second spacing less than the first spacing.

Each embossed pattern includes a plurality of prisms arranged substantially parallel to the strips of light diffusing parts. Each embossed pattern has an enclosed peripheral shape.

A planar surface area may be disposed within the first spacing and the second spacing.

Thus, according to the present invention, the bright line of the backlight assembly is decreased to improve an image display quality of the LCD device.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing an exemplary embodiment of a backlight assembly in accordance with the present invention;

FIG. 2 is a cross-sectional view showing the exemplary backlight assembly shown in FIG. 1;

FIG. 3 is a plan view showing a rear surface of an exemplary diffusion plate shown in FIG. 1;

FIG. 4 is a perspective view showing an exemplary embossed pattern shown in FIG. 3;

FIG. 5 is a cross-sectional view taken along line I-I′ shown in FIG. 4;

FIG. 6 is. a cross-sectional view showing another exemplary embodiment of an embossed pattern in accordance with the present invention;

FIG. 7 is a cross-sectional view showing another exemplary embodiment of an embossed pattern in accordance with the present invention;

FIG. 8 is a cross-sectional view showing another exemplary embodiment of an embossed pattern in accordance with the present invention;

FIG. 9 is a cross-sectional view showing another exemplary embodiment of an embossed pattern in accordance with the present invention;

FIG. 10 is a cross-sectional view showing another exemplary embodiment of an embossed pattern in accordance with the present invention;

FIG. 11 is a plan view showing another exemplary embodiment of a light diffusing part in accordance with the present invention; and

FIG. 12 is an exploded perspective view showing an exemplary embodiment of an LCD device in accordance with the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected to or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

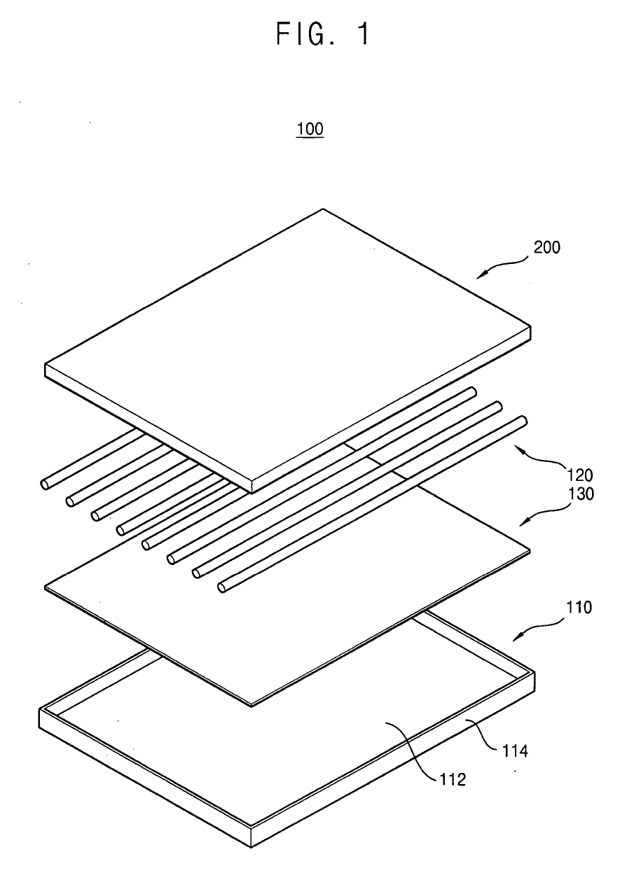

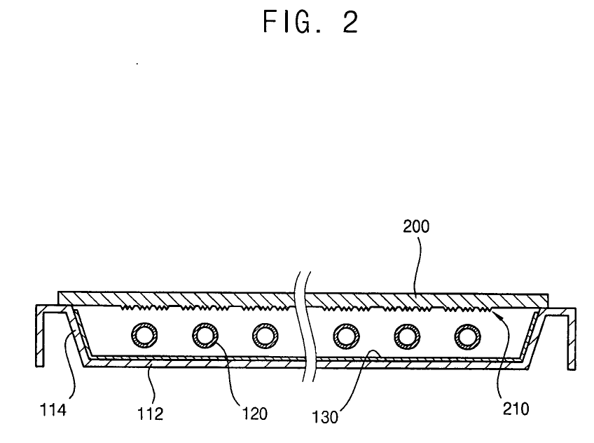

FIG. 1 is an exploded perspective view showing an exemplary embodiment of a backlight assembly in accordance with the present invention. FIG. 2 is a cross-sectional view showing the exemplary backlight assembly shown in FIG. 1.

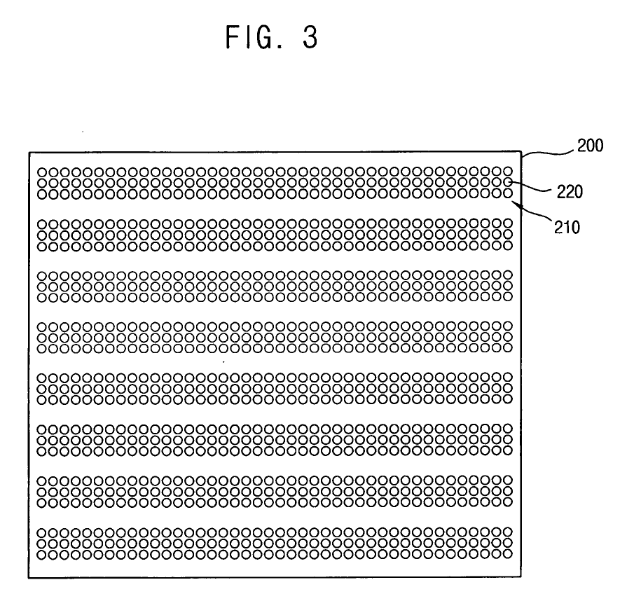

FIG. 3 is a plan view showing a rear surface of an exemplary diffusion plate shown in FIG. 1.

Referring to FIGS. 1 to 3, the backlight assembly 100 includes a receiving container 110, a plurality of lamps 120, a reflecting member 130, and a diffusion plate 200.

The receiving container 110, which receives the lamps 120, includes a bottom portion 112 and a side portion 114. The bottom portion 112 may have a rectangular shape as illustrated, although other shapes are within the scope of these embodiments. The side portion 114 is protruded from sides of the bottom portion 112. A portion of the side portion 114 is bent to form an inverted U shape as shown in FIG. 1 so that the side portion 114 is securely combined with other elements such as a chassis, a mold frame, etc., and the inverted U shaped side portion 114 forms a receiving space for the other elements. The receiving container 110 has strong metal that may not be deformed. Alternatively, the receiving container 110 may have a plastic or other suitably strong material.

The lamps 120 are received in the receiving container 110, and the lamps 120 are substantially in parallel with each other. The lamps 120 may extend in a direction generally parallel to a first pair of opposing side walls of the side portion 114 and in a direction generally perpendicular to a second pair of opposing side walls of the side portion 114. The lamps 120 generate a light based on an electric power that is provided from an inverter (not shown). The inverter may be positioned on a rear surface of the receiving container 110 with an electrical connector extending from the inverter to end portions of the lamps 120. By example only, the lamps 120 are cold cathode fluorescent lamps (“CCFL”). The lamps 120 are spaced apart from each other by a constant distance, that is, equidistantly spaced, to generate light having a uniform luminance. The number of the lamps 120 may be changed based on a required or desired luminance of the backlight assembly 100 and also may be changed based on a size of the backlight assembly 100.

Although the illustrated lamps 120 are shown to be generally rod-shaped, alternate light sources for the backlight assembly 100 are within the scope of these embodiments. For example, each of the lamps 120 may have a U shape. Alternatively, each of the lamps 120 may be an external electrode fluorescent lamp (“EEFL”). The backlight assembly 100 may also include a plurality of light emitting diodes (“LED”) as the light source.

The diffusion plate 200 is positioned over the lamps 120 to diffuse the light generated from the lamps 120 to increase a luminance uniformity of the light produced by the lamps 120. The diffusion plate 200 has a quadrangular plate shape having a predetermined thickness. The diffusion plate 200 is spaced apart from the lamps 120 by a predetermined distance. By example only, the diffusion plate 200 may include, but is not limited to, polymethylmethacrylate (“PMMA”). The diffusion plate 200 may include a diffusing agent.

The diffusion plate 200 may include a plurality of light diffusing parts 210 to improve the luminance uniformity of the backlight assembly 100. The light diffusing parts 210 are formed on an upper surface or a lower surface of the diffusion plate 200. That is, the light diffusing parts 210 may be formed on a light entering surface that faces the lamps 120, or the light diffusing parts 210 may be formed on a light exiting surface that faces a display panel. Alternatively, the light diffusing parts 210 may be formed on both the upper and the lower surface of the diffusion plate 200. The light diffusing parts 210 correspond in location to the lamps 120. The light diffusing parts 210 diffuse the light toward a space on a display panel positioned over the diffusion plate 200 between adjacent lamps 120 to decrease a bright line created by the lamps 120 on the display panel. Each light diffusing part 210 may be formed in a strip shape, and may be spaced from adjacent light diffusing parts 210 by a first spacing. The light diffusing parts 210 may be arranged in parallel.

As shown in FIG. 3, the light diffusing parts 210 include a plurality of embossed patterns 220, each embossed pattern 220 having a dot shape. The embossed patterns 220 are aligned substantially in parallel with a longitudinal direction of the lamps 120 to form at least one line. As illustrated, three lines of the embossed patterns 220 form the strip shape of one light diffusing part 210. In alternative embodiments, more or less lines of the embossed patterns 220 may be included in each light diffusing part 210. The adjacent lines of the embossed patterns 220 are separated by a second spacing that is less than the first spacing between adjacent light diffusing parts 210.

The embossed patterns 220 may be formed through a stamping process. That is, a stamper having an embossed shape corresponding to the embossed patterns 220 is formed, and the stamper is then heated and pressed to form the embossed patterns 220 on the diffusion plate 200. When the embossed patterns 220 are formed through the stamping process, a manufacturing process is simplified, and a manufacturing cost is decreased as compared to an extrusion process. Alternatively, a thin sheet having the embossed patterns may be attached to a plate to form the diffusion plate 200.

The backlight assembly 100 may further include a reflecting member 130 between the lamps 120 and the bottom portion 112 of the receiving container 110. A portion of the light generated from the lamps 120 is reflected from the reflecting member 130 to improve the luminance of the backlight assembly 100. The reflecting member 130 has a highly reflective material. Examples of the highly reflective material that can be used for the reflecting member 130 include, but are not limited to, polyethylene terephthalate (“PET”) that is white and polycarbonate (“PC”). Alternatively, when the receiving container 110 has a highly reflective material, the reflecting member 130 may be omitted.

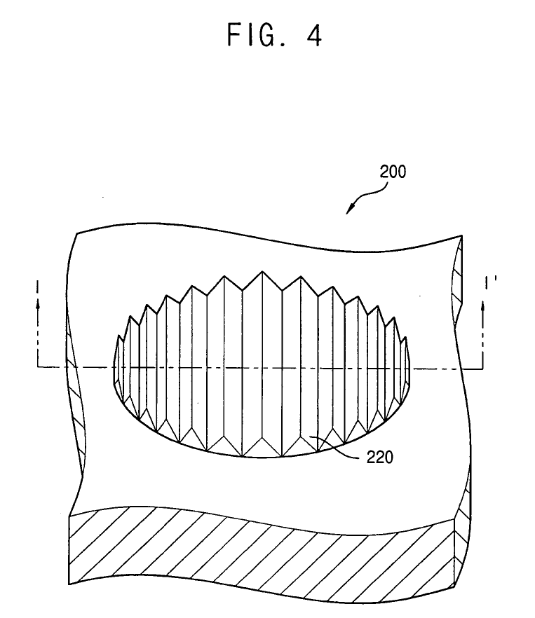

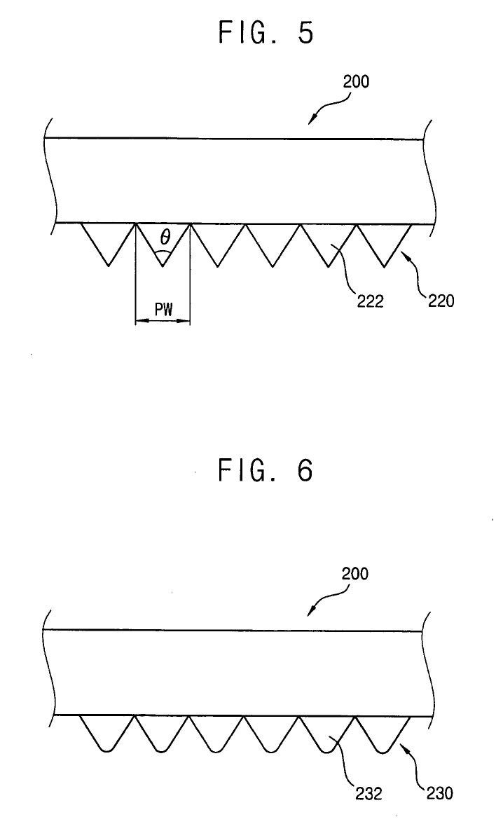

FIG. 4 is a perspective view showing an exemplary embossed pattern shown in FIG. 3. FIG. 5 is a cross-sectional view taken along line I-I′ shown in FIG. 4.

Referring to FIGS. 4 and 5, each of the embossed patterns 220 has a substantially circular shape on its outermost periphery. Each of the embossed patterns 220 is protruded from a surface of the diffusion plate 200 to form a convex shape. Although illustrated as protruding from a lower surface of the diffusion plate 200, alternatively, the embossed patterns 220 may instead be protruded from the upper surface of the diffusion plate 200, or from both upper and lower surfaces of the diffusion plate 200.

Each of the embossed patterns 220 has a plurality of first prisms 222 that are substantially in parallel with each other. as illustrated, the first prisms 222 are adjacent to each other with no spacing between adjacent first prisms 222. Alternatively, the first prisms 222 may be spaced apart from each other by a predetermined distance. The first prisms 222 may extend lengthwise substantially in parallel with the longitudinal direction of the lamps 120. Also, because the embossed patterns are substantially circular shaped, a centralmost first prism 222 within each embossed pattern 220 has a greatest length and the length of successive first prisms 222 decreases, with the first prisms 222 furthest away from the centralmost first prism 222 having the shortest lengths.

Each of the first prisms 222 has a triangular cross-section. A pitch PW of the first prisms 222 is about 10 μm to about 100 μm. An apex angle θ of each of the first prisms 222 is about 60° to about 120°. By example only, each of the first prisms 222 has the pitch PW of about 50 μm and the apex angle θ of about 82°.

FIG. 6 is a cross-sectional view showing another exemplary embodiment of an embossed pattern in accordance with the present invention.

Referring to FIGS. 4 and 6, the embossed pattern 230 is protruded from a surface of a diffusion plate 200 to form a convex shape.

The embossed pattern 230 has a plurality of second prisms 232 that are substantially in parallel with each other. As illustrated, the second prisms 232 are adjacent to each other with no spacing between adjacent second prisms 232. Alternatively, the second prisms 232 may be spaced apart from each other by a predetermined distance. The second prisms 232 may extend lengthwise substantially in parallel with a longitudinal direction of lamps 120 (shown in FIG. 1).

Each of the second prisms 232 has a triangular cross-section. An apex of each of the second prisms 232 has a rounded shape to increase a light diffusivity. The second prisms 232 of FIG. 6 are substantially the same as the first prisms 222 shown in FIG. 5 except for the apex. Thus, any further explanations concerning the above elements are omitted.

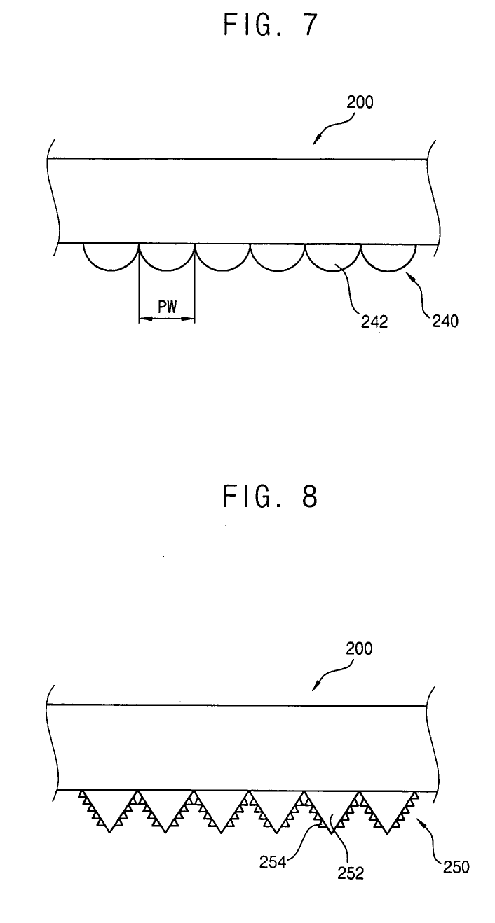

FIG. 7 is a cross-sectional view showing another exemplary embodiment of an embossed pattern in accordance with the present invention.

Referring to FIGS. 4 and 7, the embossed pattern 240 is protruded from a surface of a diffusion plate 200 to form a convex shape.

The embossed pattern 240 has a plurality of third protrusions 242 that are substantially in parallel with each other. The third protrusions 242 are adjacent to each other with no spacing between adjacent third protrusions 242. Alternatively, the third protrusions 242 may be spaced apart from each other by a predetermined distance. The third protrusions 242 may extend lengthwise substantially in parallel with a longitudinal direction of lamps 120 (shown in FIG. 1).

Each of the third protrusions 242 has a semi-elliptical cross-section. Alternatively, each of the third protrusions 242 may have a semi-circular cross-section. A pitch PW of the third protrusions 242 is about 10 μm to about 100 μm. By example only, the pitch PW of each of the third protrusions 242 may be about 50 μm.

FIG. 8 is a cross-sectional view showing another exemplary embodiment of an embossed pattern in accordance with the present invention.

Referring to FIGS. 4 and 8, the embossed pattern 250 is protruded from a surface of a diffusion plate 200 to form a convex shape.

The embossed pattern 250 has a plurality of fourth prisms 252 that are substantially in parallel with each other. As illustrated, the fourth prisms 252 are adjacent to each other with no spacing between adjacent fourth prisms 252. Alternatively, the fourth prisms 252 may be spaced apart from each other by a predetermined distance. The fourth prisms 252 may extend lengthwise substantially in parallel with a longitudinal direction of lamps 120 (shown in FIG. 1).

Each of the fourth prisms 252 has a triangular cross-section. Each of the fourth prisms 252 may have a plurality of minute protrusions 254 on a surface of each of the fourth prisms 252 to increase a diffusivity of the diffusion plate 200. The minute protrusions may have various shapes such as a triangular prism shape, a pyramid shape, etc. The fourth prisms 252 of FIG. 8 are substantially the same as the first prisms 222 shown in FIG. 5 except for the minute protrusions 254. Thus, any further explanations concerning the above elements are omitted.

Although not illustrated, in alternate embodiments, the second prisms 232 of FIG. 6 or the third protrusions 242 of FIG. 7 may include the minute protrusions 254 shown in FIG. 8.

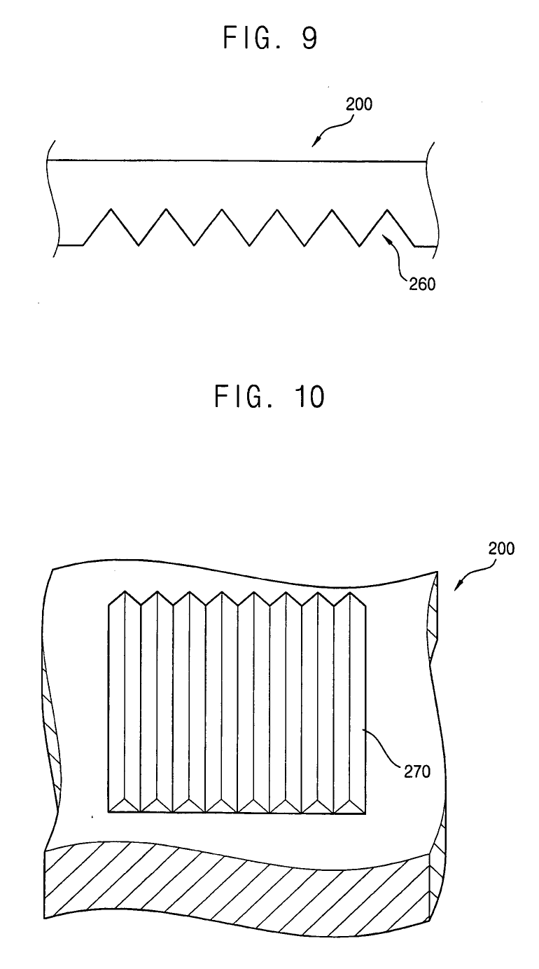

FIG. 9 is a cross-sectional view showing another exemplary embodiment of an embossed pattern in accordance with the present invention.

Referring to FIGS. 4 and 9, the embossed pattern 260 is recessed from a surface of a diffusion plate 200 to form a concave shape. The embossed pattern 260 of FIG. 9 is substantially the same as the embossed pattern 220 in FIG. 5 except for the concave shape. Thus, any further explanations concerning the above elements will be omitted. Although illustrated as recessing from a lower surface of the diffusion plate 200, alternatively, the embossed patterns 260 may instead be recessed from the upper surface of the diffusion plate 200, or from both upper and lower surfaces of the diffusion plate 200.

Although not illustrated, in other embodiments, the second prisms 232 of FIG. 6, the third protrusions 242 of FIG. 7, or the fourth prisms 252 of FIG. 8 may also have the concave shape as opposed to the illustrated convex shapes. In yet other embodiments, one surface (upper or lower) of the diffusion plate 200 may include convex embossed patterns and another surface (upper or lower) of the diffusion plate 200 may include concave embossed patterns.

FIG. 10 is a perspective view showing another exemplary embodiment of an embossed pattern in accordance with the present invention.

Referring to FIG. 10, the embossed pattern 270 has a substantially quadrangular shape when plan-viewed. Alternatively, the embossed pattern 270 may have various peripheral shapes such as a pentagonal shape, a hexagonal shape, etc.

The prisms of the embossed pattern of FIG. 10 may be substantially the same as any of the prisms previously described with respect to the embossed patterns of FIGS. 5 to 9. Thus, any further explanations concerning the above elements will be omitted.

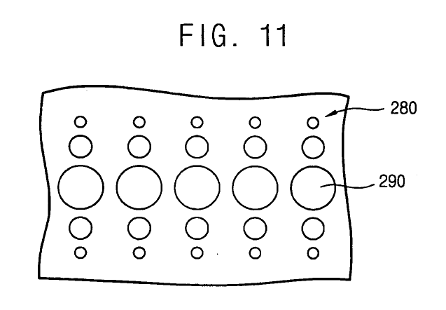

FIG. 11 is a plan view showing another exemplary embodiment of a light diffusing part in accordance with the present invention.

Referring to FIGS. 4 and 11, the light diffusing part 280 is formed on an upper surface or a lower surface of the diffusion plate 200 corresponding to the lamps 120. Alternatively, the light diffusing part 280 is formed on both the upper surface and the lower surface of the diffusion plate 200. The light diffusing part 280 has a plurality of embossed patterns 290 that have a dot shape.

The embossed patterns 290 are aligned substantially in parallel with a longitudinal direction of the lamps 120 to form at least one line. In FIG. 11, a size of each of the embossed patterns 290 is decreased as a distance of each of the embossed patterns 290 from a center of the lamps 120 is increased. That is, the embossed pattern 290 at a position corresponding to the center of the lamps 120 has a larger size than the embossed pattern 290 between adjacent lamps 120 to increase a diffusivity of the diffusion plate 200 at the center of the lamps 120. For example, the sizes of the embossed patterns 290 decrease sequentially from a first lamp-aligned embossed pattern, increase sequentially towards a second lamp-aligned embossed pattern, decrease sequentially from a second lamp-aligned embossed pattern, increase sequentially towards a third lamp-aligned embossed pattern, and so on. When the embossed patterns 290 have the various sizes, a luminance uniformity of a backlight assembly is increased.

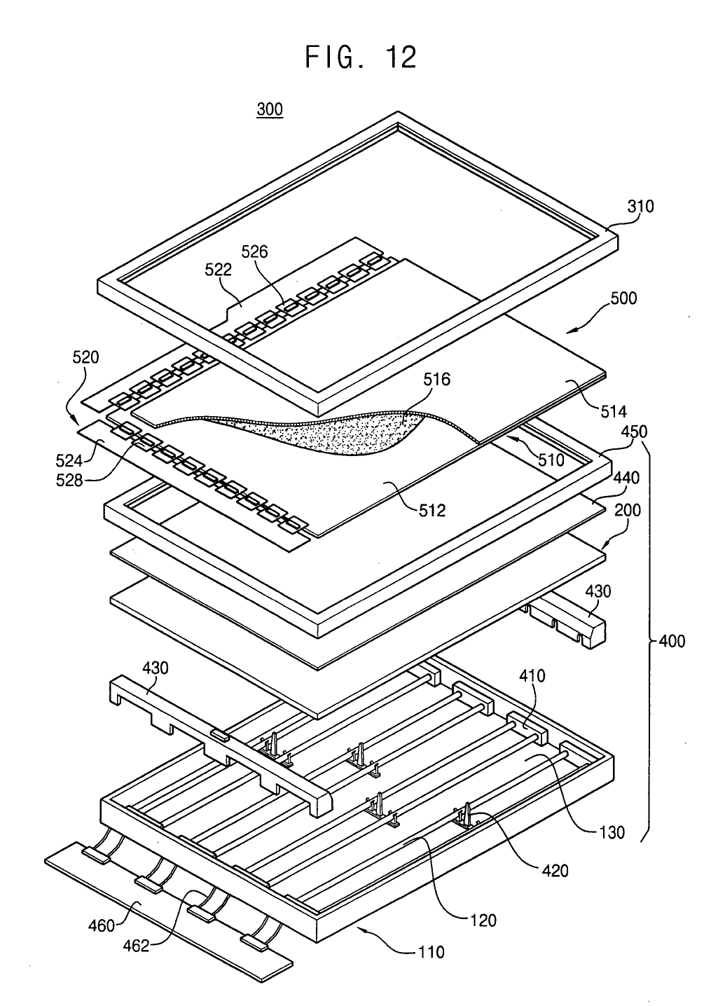

FIG. 12 is an exploded perspective view showing an exemplary embodiment of an LCD device in accordance with the present invention.

Referring to FIG. 12, the LCD device 300 includes a backlight assembly 400 and a display unit 500. The backlight assembly 400 generates a light. The display unit 500 displays an image using the light generated from the backlight assembly 400.

The backlight assembly 400 includes a receiving container 110, a plurality of lamps 120, a diffusion plate 200, and a reflecting member 130. The receiving container 110, the lamps 120, the diffusion plate 200, and the reflecting member 130 in FIG. 12 are the same as previously illustrated in and described with respect to FIGS. 1 to 11. Thus, the same reference numerals will be used to refer to the same or like parts as those described in FIGS. 1 to 11 and any further explanation concerning the above elements will be omitted.

The backlight assembly 400 further includes a lamp holder 410, a lamp supporter 420, and a side mold 430. The lamp holder 410 holds end portions of the lamps 120 and the side mold 430 is on the end portions of the lamps 120.

The lamp holder 410 is combined with the end portions of the lamps 120 to fix the lamps 120 to the receiving container 110. The lamp holder 410 that is combined with the lamps 120 is combined with the receiving container 110. By example only, each of the lamp holders 410 may be combined with two lamps 120 that are adjacent to each other.

The lamp supporter 420 is combined with the receiving container 110, or alternatively the reflecting member 130, to support central portions of the lamps 120 to securely fix the central portions of the lamps 120 to the receiving container 110. The lamp supporters 420 are aligned substantially perpendicular to a longitudinal direction of the lamps 120 to form a zigzag shape to decrease a shadow line. When the lamp supporters 420 are aligned to form a straight line, the shadow line is formed along the straight line. In FIG. 12, the lamp supporters 420 are aligned to form the zigzag line to decrease the shadow line.

The side mold 430 is on the end portions of the lamps 120 to support the diffusion plate 200 above the lamps 120. The side mold 430 covers the lamp holders 410 to fix the lamp holders 410 to the receiving container 110. The backlight assembly 400 corresponding to the end portions of the lamps 120 has smaller luminance than the backlight assembly 400 corresponding to the central portions of the lamps 120. The side mold 430 blocks the end portions of the lamps 120 to increase the luminance uniformity of the backlight assembly 400. In addition, the side mold 430 supports the diffusion plate 200 that is on the side mold 430 to guide the diffusion plate 200.

The backlight assembly 400 may further include optical sheets 440, a middle mold 450, and an inverter 460. The optical sheets 440 are positioned on the diffusion plate 200. The middle mold 450 supports sides of the diffusion plate 200 and the optical sheets 440. The inverter 460 applies an electric power to the lamps 120.

The optical sheets 440 are positioned on or over the diffusion plate 200 to guide the light that has passed through the diffusion plate 200 to improve optical characteristics of the light. The optical sheets 440 may include a brightness enhancement sheet that increases a luminance when viewed on a plane of the backlight assembly 400. In addition, the optical sheets 440 may further include a diffusion sheet that diffuses the light that is diffused by the diffusion plate 200 to increase the luminance uniformity. The optical sheets 440 may further include additional sheets. Alternatively, one or more of the optical sheets 440 may be omitted.

The middle mold 450 is combined with the receiving container 110 to fix the diffusion plate 200 and the optical sheets 440 to the receiving container 110. The middle mold 450 is positioned on an upper surface of the optical sheets 440 adjacent to a peripheral edge of the optical sheets 440 to press the optical sheets 440 and the diffusion plate 200. The middle mold 450 is combined with a side portion 114 (shown in FIG. 1) of the receiving container 110. Alternatively, since the middle mold 450 is difficult to be formed as one mold as the size of the middle mold 450 increases, two or four piece molds may be combined with each other to form the middle mold 450.

The inverter 460 is positioned on a rear surface of the receiving container 110 to generate the electric power to drive the lamps 120. The inverter 460 elevates a level of an externally provided electric power to apply the electric power to the lamps 120. The electric power generated from the inverter 460 is applied to the lamps 120 through lamp wires 462.

The display unit 500 includes an LCD panel 510 and a driving circuit member 520. The LCD panel 510 displays an image using the light generated from the backlight assembly 400. The driving circuit member 520 drives the LCD panel 510.

The LCD panel 510 includes a first substrate 512, a second substrate 514, and a liquid crystal layer 516. The second substrate 514 is combined with the first substrate 512. The liquid crystal layer 516 is interposed between the first and second substrates 512 and 514.

The first substrate 512 is a thin film transistor (“TFT”) substrate including a plurality of TFTs that are arranged in a matrix shape. By example only, the first substrate 512 includes a transparent glass and a plurality of parallel gate lines and data lines extending perpendicular with respect to the gate lines. A source electrode and a gate electrode of each of the TFTs are electrically connected to a data line and a gate line, respectively. A drain electrode of each of the TFTs is electrically connected to a pixel electrode that has a transparent conductive material.

The second substrate 514 is a color filter substrate that includes red, green and blue pixels. By example only, the second substrate 514 includes a transparent glass. The second substrate 514 may further include a common electrode that has a transparent conductive material.

When electric power is applied to the gate electrode of the TFT, the TFT is turned on so that an electric field is formed between the pixel electrode (not shown) and the common electrode (not shown). Liquid crystal molecules in the liquid crystal layer 516 varies arrangement in response to the electric field applied thereto, and thus a light transmittance thereof may be changed to display an image.

The driving circuit member 520 includes a data printed circuit board (“PCB”) 522, a gate PCB 524, a data flexible circuit film 526, and a gate flexible film 528. The data PCB 522 applies a data driving signal to the LCD panel 510 through the data lines. The gate PCB 524 applies a gate driving signal to the LCD panel 510 through the gate lines. The data flexible circuit film 526 electrically connects the data PCB 522 to the LCD panel 510. The gate flexible circuit film 528 electrically connects the gate PCB 524 to the LCD panel 510. Each of the data and gate flexible circuit films 526 and 528 may be a tape carrier package (“TCP”) or a chip on film (“COF”). Alternatively, signal lines (not shown) may be directly formed on the LCD panel 510 and the gate flexible circuit film 528 so that the gate PCB 524 may be omitted.

The LCD device 300 may further include a top chassis 310 to fix the display unit 500 to the receiving container 110. The top chassis 310 is combined with the receiving container 110 to fix sides of the LCD panel 510 to the receiving container 110. The data flexible circuit film 526 is bent toward a side portion 114 (shown in FIG. 1) or a bottom portion 112 (shown in FIG. 1) of the receiving container 110 so that the data PCB 522 is fixed to the side portion 114 (shown in FIG. 1) or the bottom portion 112 (shown in FIG. 1) of the receiving container 110. For example, the top chassis 310 includes a strong metal or other suitably strong material that may not be deformed.

According to the present invention, the light diffusing part having the embossed patterns is formed on the diffusion plate at locations corresponding to the lamps to decrease the bright line, thereby improving the image display quality of the LCD device.

In addition, the embossed patterns formed on the diffusion plate only guide the light to improve the luminance uniformity so that a loss of the light is decreased, and a luminance of the backlight assembly is improved.

Further, the bright line is decreased by using the embossed patterns so that a distance between the diffusion plate and the lamps may be decreased, thereby decreasing a thickness of the backlight assembly.

Furthermore, the embossed patterns may be formed through a stamping process to simplify a manufacturing process and to decrease a manufacturing cost.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly comprising:
a receiving container;
a plurality of lamps received in the receiving container, the lamps arranged substantially in parallel with each other and generating a light; and
a diffusion plate disposed over the lamps, the diffusion plate including a plurality of light diffusing parts, each light diffusing part having a plurality of embossed patterns corresponding to the lamps.

2. The backlight assembly of claim 1, wherein each of the embossed patterns has a circular shape in plan view.

3. The backlight assembly of claim 1, wherein each of the embossed patterns has a polygonal shape in plan view.

4. The backlight assembly of claim 1, wherein each of the embossed patterns comprises a plurality of prisms, each prism having a substantially triangular cross-section.

5. The backlight assembly of claim 4, wherein the prisms are arranged substantially in parallel with a longitudinal direction of the lamps.

6. The backlight assembly of claim 4, wherein an apex of each prism is rounded.

7. The backlight assembly of claim 1, wherein each of the embossed patterns comprises a plurality of protrusions that have a semi-elliptical cross-section.

8. The backlight assembly of claim 1, wherein each of the embossed patterns comprises a plurality of protrusions that have a semi-circular cross-section.

9. The backlight assembly of claim 1, wherein each of the embossed patterns is recessed from a surface of the diffusion plate by a depth to form a concave shape.

10. The backlight assembly of claim 1, wherein each of the embossed patterns is protruded from a surface of the diffusion plate by a height to form a convex shape.

11. The backlight assembly of claim 1, wherein each of the embossed patterns comprises a plurality of minute protrusions that are protruded from a surface of each embossed pattern.

12. The backlight assembly of claim 1, wherein a size of each of the embossed patterns is decreased as a distance of each of the embossed patterns from a center of the lamps is increased.

13. The backlight assembly of claim 1, wherein the light diffusing parts are formed on an upper surface or a lower surface of the diffusion plate.

14. The backlight assembly of claim 1, further comprising a reflecting member under the lamps.

15. The backlight assembly of claim 1, wherein each light diffusing part is separated from an adjacent light diffusing part by a first spacing.

16. The backlight assembly of claim 15, wherein each light diffusing part includes a plurality of columns of the embossed patterns, each column separated from an adjacent column within a light diffusing part by a second spacing, the second spacing smaller than the first spacing.

17. The backlight assembly of claim 1, wherein the diffusion plate includes a planar surface area between adjacent light diffusing parts and between the embossed patterns.

18. A backlight assembly comprising:
a receiving container;
a plurality of lamps received in the receiving container, the lamps arranged substantially in parallel with each other and generating a light; and
a diffusion plate disposed over the lamps, the diffusion plate including a plurality of light diffusing parts, each light diffusing part having a plurality of embossed patterns corresponding to the lamps, each of the embossed patterns having a plurality of prisms arranged in a dot shape.

19. The backlight assembly of claim 18, wherein the prisms in each of the embossed patterns are aligned substantially in parallel with a longitudinal direction of the lamps.

20. A liquid crystal display device comprising:
a backlight assembly generating a light, the backlight assembly including:
a receiving container;
a plurality of lamps received in the receiving container, the lamps arranged substantially in parallel with each other to generate a light; and
a diffusion plate disposed over the lamps, the diffusion plate including a plurality of light diffusing parts, each light diffusing part having a plurality of embossed patterns corresponding to the lamps; and
a display unit displaying an image using the light generated from the backlight assembly.

21. The liquid crystal display device of claim 20, wherein each of the embossed patterns has a circular shape or a polygonal shape in plan view.

22. The liquid crystal display device of claim 20, wherein each of the embossed patterns comprises a plurality of protrusions, and each of the protrusions has a substantially triangular cross-section or a semi-elliptical cross-section.

23. The liquid crystal display device of claim 22, wherein the protrusions are substantially in parallel with a longitudinal direction of the lamps.

24. The liquid crystal display device of claim 20, wherein each of the embossed patterns comprises a plurality of minute protrusions on a surface of each of the embossed patterns.

25. The liquid crystal display device of claim 20, wherein the display unit comprises:
a liquid crystal display panel on the diffusion plate to display the image; and
a driving circuit member that drives the liquid crystal display panel.

26. A diffusion plate for diffusing light from a light source, the diffusion plate comprising:
a plurality of light diffusing parts arranged in strips on a surface of the diffusion plate; and,
a plurality of embossed patterns within each light diffusing part, each embossed pattern having an enclosed periphery and including a plurality of prisms within the enclosed periphery, the prisms arranged substantially parallel to the strips of light diffusing parts.

27. The diffusion plate of claim 26, wherein each prism is substantially triangular in cross-section.

28. The diffusion plate of claim 26, further comprising a plurality of minute protrusions on a surface of each prism.

29. The diffusion plate of claim 26, further comprising a planar surface area between adjacent light diffusing parts.

30. A diffusion plate for diffusing light from a light source, the diffusion plate comprising:
a plurality of light diffusing parts arranged in strips on a surface of the diffusion plate, each light diffusing part separated from an adjacent light diffusing part by a first spacing; and,
a plurality of spaced embossed patterns within each light diffusing part, each embossed pattern separated from an adjacent embossed pattern within a same light diffusing part by a second spacing, the second spacing less than the first spacing.

31. The diffusion plate of claim 30, wherein each embossed pattern includes a plurality of prisms arranged substantially parallel to the strips of light diffusing parts.

32. The diffusion plate of claim 30, wherein each embossed pattern has an enclosed peripheral shape.

33. The diffusion plate of claim 30, further comprising a planar surface area disposed within the first spacing and the second spacing.
